(19) United States
(12) Patent Application Publication
(10) Pub. No.: US 2008/0133320 A1
(43) Pub. Date: Jun. 5, 2008

(54) Modeling customer behavior in a multi-choice service environment

(76) Inventors: Ilya Gluhovsky, Daly City, CA (US); David Vengerov, Santa Clara, CA (US); John Busch, Cupertino, CA (US)

Correspondence Address: PVF -- SUN MICROSYSTEMS INC.;C/O PARK, VAUGHAN & FLEMING LLP, 2820 FIFTH STREET, DAVIS, CA, 95618-7759, US

(21) Appl. No.: 11/607,527

(22) Filed: Dec. 1, 2006

(51) Int. Cl. G06Q 10/00; G06F 17/10

(52) U.S. Cl. 705/10

(57) ABSTRACT

One embodiment of the present invention provides a system that models customer behavior in a multi-choice service environment. The system constructs a probability density function f to represent probabilities of service-level choices made by customers, wherein the probability density function is a function of functional variables u_{θ}(d) and p(d); u_{θ}(d) is a utility function for a specific customer type indexed by vector θ; p(d) is a given price curve which specifies a relationship between service levels offered by a service provider and corresponding prices for the offered service levels; and u_{θ}(d) and p(d) are both functions of the offered service levels d. The system then obtains a distribution function π(θ) which specifies a probability distribution of different customer types θ. Next, the system obtains a service level-choice distribution for a population of customers as a function of a given price curve based on the probability density function f and π(θ).

### BACKGROUND

1. Field of the Invention

The present invention relates to techniques for modeling customer behavior in an online service environment. More specifically, the present invention relates to a technique for modeling statistical distributions of customer service-level-choices based on a given price schedule provided by a service provider (SP).

2. Related Art

In a general service environment, customers typically send requests to a service provider (SP) to gain access to the provider's online service. A requesting customer is then provided with a service level agreement (SLA), which typically stipulates a payment to the SP per job unit for commencing the service at the client's request within a certain time frame. The SLA can also specify a penalty that the SP pays to the client if the SP fails to provide the agreed-upon service level. The SP typically offers several service levels at various prices, which generally guarantee faster response/completion times for higher payments. Next, after the customer selects a service level, customer jobs or transactions are executed on the SP's hardware at the agreed-upon service level.

The above-described general service environment can facilitate many common online practices, such as: (1) providing content (e.g., data base access, online financial information) or access to a computer program (“applications on tap”), wherein different service levels correspond to different bandwidth requirements; (2) voice or video connections; and (3) hosting e-commerce web sites of client businesses.

In a typical system configuration, the client business provides an e-commerce application, and the SP maintains a commercial database and services customers of the client business. Moreover, the SLAs stipulate the responses for commercial transactions that originate from a customer. For example, suppose a high productivity computing (HPC) customer submits a large, typically multithreaded job and receives a guarantee of getting results by a certain time. The job unit is usually “CPU time”, while other job requirements, such as storage, are not priced according to the service level.

A customer behavior model (CBM) summarizes the choices that a typical customer makes when presented with a price curve which relates a given service level to its price per job unit. Note that the notion of a customer is viewed broadly to also include different jobs or transaction types even if they originate from the same physical customer due to the fact that different jobs may carry different requirements. During system operation, an SP observes an inflow of jobs and their corresponding service levels. As the SP varies the price curve, the job arrival rate and the distribution of the service levels change consequently. For example, if the SP raises the price of a premium service, some customers who depend on it are going to leave and subscribe to a service with a competitor or they may maintain their own system. As a result, the job arrival rate will decrease. Additionally, some customers would choose a lower service level, which becomes relatively more attractive. Hence, the distribution of service levels would give more weight to lower service levels. Note that these customer behaviors are functions of the entire price curve.

Also note that a price schedule can greatly impact the job flow and the revenue of a SP offering the service. From the SP's perspective, a price schedule should be chosen to optimize its revenue/profit. To achieve this, it is highly desirable to build high-reliability CBMs to accurately estimate the rate of job arrivals and the distribution of the service-level choices for any price curve that is offered to the customers.

A common “brute force” approach to estimating customer demand for a particular level of service is to fit a regression model to the observed customer demand as a response and the corresponding prices for “all” service levels as predictors. In this approach, if n (discrete) service levels are offered, n regression models have to be fitted with n predictors in each of the n regression models.

Unfortunately, the regression model approach does not scale well for continuous service levels. Note that a regression model requires that either a particular parametric functional form for each model be supplied or that the models be fitted nonparametrically. In both cases one needs a large data set to obtain models with reasonable accuracy. This is because the n predictors are expected to interact in nontrivial ways, and one has to include interaction terms into the model. For example, one existing regression technique uses a 17-degree polynomial to capture this behavior. Consequently, unless the number of service levels is relatively small, these regression models are unlikely to be practical.

Another limitation associated with the regression models relates to the fact that when a large number of service levels are offered, a customer who has chosen a particular service level typically indicates that there exist other service levels that are almost equally as attractive to this customer. Furthermore, customers are not expected to always choose the absolute best service level among the offerings, but rather expected to choose a sufficiently satisfactory “near-best” one. Unfortunately, the regression models could not distinguish the absolute best and near-best choices to provide adequate weights to service levels in the proximity of the chosen service level.

Yet another problem of the regression models has to do with adaptability of the model to new service level offerings (e.g. adding another level of service to the existing ones). In such situations, a regression model typically has to be refitted from scratch and moreover, data for the existing model cannot be reused. This rebuilding of the model each time changes arise is highly undesirable in a dynamic changing service environment.

Hence, what is needed is a method for constructing a CBM suitable for both static and dynamic price schedules without the problems described above.

### SUMMARY

One embodiment of the present invention provides a system that models customer behavior in a multi-choice service environment. The system constructs a probability density function f to represent probabilities of service-level choices made by customers, wherein the probability density function is a function of functional variables u_{θ}(d) and p(d); u_{θ}(d) is a utility function for a specific customer type indexed by vector θ; p(d) is a given price curve which specifies a relationship between service levels offered by a service provider and corresponding prices for the offered service levels; and u_{θ}(d) and p(d) are both functions of the offered service levels d. The system then obtains a distribution function π(θ) which specifies a probability distribution of different customer types θ. Next, the system obtains a service level-choice distribution for a population of customers as a function of a given price curve based on the probability density function f and π(θ).

In a variation on this embodiment, the system uses the service-level choice distribution to estimate customer behavior for any given price curve and a rate of customers receiving services for any give price curve.

In a variation on this embodiment, the probability density function f is proportional to a nonnegative decreasing function

$$G ( \frac{{u}_{0}^{θ , p} - ( {u}_{θ} ( d ) - p ( d ) )}{σ} ) ,$$

wherein u₀^{θ,p} is an optimal utility gain under p(d) for customer type θ;

wherein u_{θ}(d)-p(d) is the utility gain under p(d) for customer type θ;

wherein u₀^{θ,p} (u_{θ}(d)-p(d)) represents a departure from the optimal utility gain for customer type θ; and

wherein σ is a constant which represents the extent of the departure from the optimal utility gain.

In a variation on this embodiment, the system obtains the service level-choice distribution f(d\p(d)) for a given price curve p(d) based on the probability density function f and π(θ) by integrating over the customer type θ using: f(d\p(d))=∫ f(d\θ, p(d))π(θ)dθ.

In a variation on this embodiment, the service-level choices include leaving without receiving service.

In a variation on this embodiment, the system obtains the distribution function π(θ) by: collecting service-level-choices data {d} from a population of N customers; and computing the distribution function π(θ) by computing a distribution function π(θ\d) based on the service-level-choices data {d}.

In a further variation on this embodiment, the system collects service-level-choices data {d} from the N customers by: offering the N customers with one or more price curves; and for each customer i, recording one or more service-level choices dᵢ made by the customer i based on each offered price curve.

In a further variation on this embodiment, the system collects service-level-choices data {d} from the N customers by collecting one or more identical service-level-choices made by a same customer.

In a further variation on this embodiment, the system obtains the distribution function π(θ\d) by: obtaining a distribution function π(θ\τ), wherein τ is a hyperparameter; obtaining a distribution function ξ(τ\d) for the hyperparameter τ giving the collected data {d}; and computing the distribution function π(θ\d) by performing the integral: π(θ\d)=∫ π(θ\τ)ξ(τ\d)dθ.

In a further variation, the system generates a representative collection of utility functions to represent a plurality of customer types θₘ, wherein the collection of utility functions uniformly cover a space containing different utility functions.

In a further variation, the collection of utility functions are represented by nonincreasing convex curves.

In a further variation, the system computes the distribution function π(θ\d) by computing a probability density vector f(dᵢ\θₘ) for each customer i over the plurality of customer types θₘ.

In a further variation, the system obtains the distribution function π(θ\τ) by using a Gibbs sampler.

In a variation on this embodiment, the system represents p(d) as a combination of a wavelet basis, thereby facilitating varying p(d) during an optimization process using the service-level choice distribution.

In a further variation, the system updates the distribution function π(θ\d) when new customer data is added in {d}.

### BRIEF DESCRIPTION OF THE FIGURES

FIG. 1 illustrates a multi-choice service environment in accordance with an embodiment of the present invention.

FIG. 2A illustrates a wavelet scaling function φ(x) in accordance with an embodiment of the present invention.

FIG. 2B illustrates a representative set of 50 utility curves u_{θ} in accordance with an embodiment of the present invention.

FIG. 3 presents a flowchart illustrating the process of computing the service-level choice distribution in accordance with an embodiment of the present invention.

FIG. 4A illustrates four training prices curves (solid) and five testing prices curves (dashed) in accordance with an embodiment of the present invention.

FIG. 4B illustrates the cumulative distribution functions (cdfs) of the chosen delays corresponding to price curves 3 (in the training set), 6 and 9 (in the test set) in accordance with an embodiment of the present invention.

FIG. 5A illustrates four of the set of 22 test price curves generated for collecting customer data in accordance with an embodiment of the present invention.

FIG. 5B illustrates the estimated and simulated delay distributions for the four test curves plotted in FIG. 5A in accordance with an embodiment of the present invention.

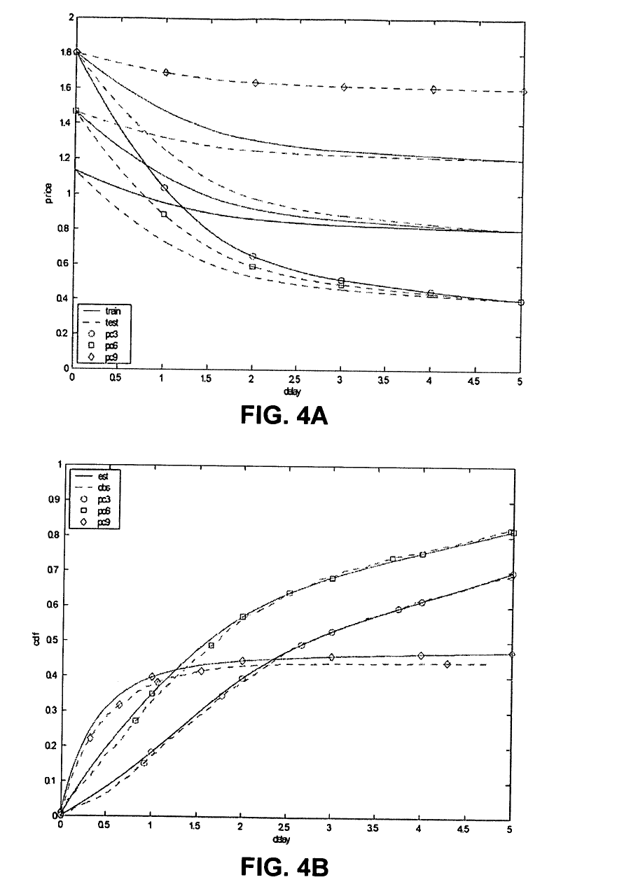

Table 1 summarizes the comparison of the estimated and simulated data for all nine price curves in FIG. 4A in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer readable media now known or later developed.

### Overview

We view a customer behavior model (CBM) as part of a larger service provider (SP) framework. An SP is ultimately interested in optimizing his revenue/profit. By having a CBM available, the SP knows the demand structure for any price curve that can be offered. Consequently, for a given price curve the SP can accurately provision computational resources necessary to fulfill the majority of the service level agreements (SLA) as well as optimize job scheduling. Furthermore, the SP can choose the price curve that maximizes revenue/profit. The proposed CBM also adapts naturally to changing market conditions.

### A Multi-Choice Service Environment

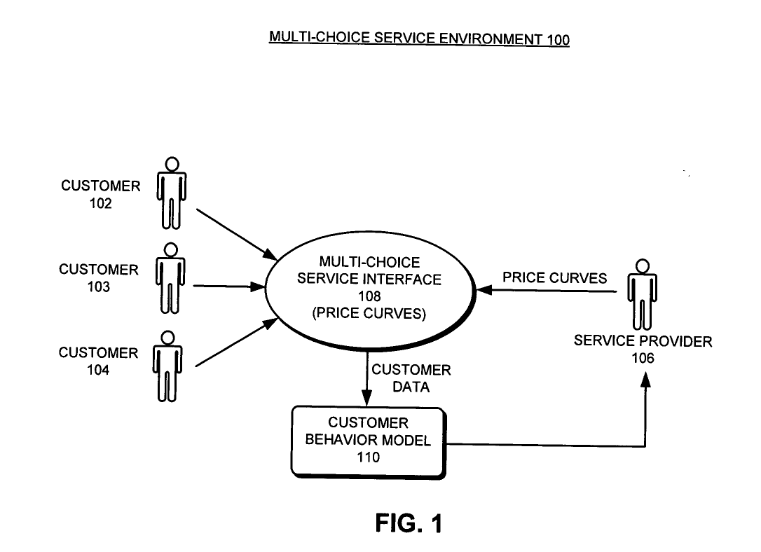

FIG. 1 illustrates a multi-choice service environment 100 in accordance with an embodiment of the present invention. Service environment I 00 includes a number of customers 102-104. Each of customers 102-104 can request services from service provider 106 through a multi-choice service interface 108. More specifically, service provider 106 offers a set of price curves to customers 102-104 through service interface 108, wherein each price curve specifies a unique price schedule between a plurality of service levels and corresponding costs for choosing each of the service levels. In response, customers 102-104 make service-level choices based on the prices curves. The decisions made by customers 102-104 are collected as customer behavior data and subsequently used to construct a customer behavior model 110. Service provider 106 can use the customer behavior model 110 to accurately provision computational resources to meet customer demand and choose a price curve that maximize its own revenue/profit.

Note that the present invention can generally be used in any utility environment wherein customers receives services from service providers based on service level agreements and hence is not meant to be limited to the exemplary service environment illustrated in FIG. 1.

### Constructing a Customer Behavior Model

Defining Components in the Customer Behavior Model

We first describe basic components that are comprised in a customer behavior model (CBM).

A typical customer makes a decision on which service level to choose based on a tradeoff between quality-of-services and associated costs. In the following discussion of constructing a customer behavior model, we consider online service applications, wherein service levels are associated with different delays d, which customers receiving the services experience. Note that however, the general technique used to obtain a CBM below is not limited to just the online service applications, and service levels are not just limited to the delays.

Typically in online service applications, a higher service level offers smaller delay d. We use p(d) to represent the cost to the customer for choosing a specific service level associated with delay d, wherein p(d) is referred to as a price curve. The service provider can specify one or more price curves p(d) for customers entering the SLA associated with delay d. We assume that a typically customer prefers a lower cost and a service level associated with a smaller delay.

For example, in the high productivity utility computing context, let d=t/te−1, where t is time a customer job is in the system, te is the n-CPU execution time measured in hours. Let p be the dollar cost per CPU-hour. Furthermore, an associated SLA stipulates that the customer pays $p=$p(d) per CPU-hour. Hence, the customer pays a total amount of $p×n×te for this service level choice. If the delay of the customer job is greater than d, that is, the job does not complete in (1+d)te hours, the service provider repays the customer, for example, $p/2×n for each additional delay hour.

Let u(d) be the utility function of the customer from receiving the service level associated with delay d. Note that u(d) is specific to a particular customer type, therefore can be used to infer customer behavior. It is expected that additional delays should have progressively less impact on the customer utility, hence u(d) typically is assumed to be a convex (and decreasing) function.

Note that the offered service level choices for a customer can include leaving without receiving a service, which is denoted by d=d_. We can define u_{θ}(d_)=0 as the customer receives no benefit (in utility) by choosing d_, wherein θ is a index parameter representing a particular customer type. It is reasonable to assume that p(d_)=0. When the price curve is provided, the set of possible delay-cost points is given by: {(d; p(d)):d≧0∪d=d_}.

As one can appreciate that a rational customer would choose an optimal delay d*=arg max_{d}{u(d)−p(d)}, wherein u(d)−p(d) is the customer surplus. In particular, d*=d_ if there does not exist a service delay with a positive customer profit. For example, if a retailer receives (potential) profit from client transactions, then u(d) is the expected retailer profit and u(d)−p(d) is the expected net operational gain to be maximized.

Note that the above formulation of d* may not be accurate in some situations. For example, if a utility customer operates within a specific budget and has an unlimited number of jobs, cheaper jobs become more valuable to this customer when the whole curve p(d) shifts downward, because the customer can now run proportionately more cheap jobs. For example, given a budget of $600, and prices $6 and $4 for two service levels, the customer can run 100 fast jobs or 150 slow jobs. However, with prices for the same two service levels dropped to $4 and $2 respectively, the customer can run 150 fast or 300 slow jobs and the latter is considered more valuable to the customer. Hence, the above formulation of d* may be modified if necessary.

The goal of a service provider is to infer customer behavior summarized by the utility functions u(d). Ideally, one could ask customers to provide their utility functions. However, this is a generally unrealistic. First, the customer may be unwilling to cooperate. Second, the customer may not be able to formulate his relative preferences in terms of a utility curve. Third, customer's preferences may change over time. In the following discussion, we describe a process for inferring customer behavior based on the service-level choices that customers make when they are offered one or more price curves. We start by defining a probability distribution function of service-level choices made by a population of customers of different types.

### Probability Density Function of Customer Choices

Assume there exists a collection of customer utility functions u_{θ}(d) indexed by customer type parameter θ. A random customer i arrives and makes nᵢ delay choices dᵢ=(dᵢⱼ; 1≦j≦nᵢ) according to the associated preference type θᵢ. Let f denote the probability density function of the chosen delays. We propose that when offered with a price curve p(d) and given that a customer chooses to receive the provided service, the customer associated with utility function u_{θ}(d) makes a near-optimal choice according to the following f distribution:

$$f \text{(} d \vert θ , p ( . ) , d \neq {d}_{-} ) = \frac{1}{K ( θ , p )} G ( \frac{{u}_{0}^{θ , p} - ( {u}_{θ} ( d ) - p ( d ) )}{σ} ) , \qquad ( 1 )$$

wherein:
u₀^{θ,p}=max_{d≧0∪d=d}_{_{—}} u_{θ}(d)−p(d) is the optimal utility gain for customer type θ;

### G is a nonnegative decreasing function of argument u₀^{θ,p}−(u_{θ}(d)−p(d));

σ is a constant which provides the extent of departure from optimality; and

### K (θ; p) is normalization constant.

Note that the argument u₀^{θ,p}−(u_{θ}(d)−p(d)) in function G represents a departure from the optimal utility gain. Furthermore, choosing G as a nonnegative decreasing function implies that the customer is unlikely to choose d far from the optimum. However, the formulation allows some degree of non-optimality in customer choice because a customer is expected to have difficulty in comparing near-optimal alternatives and would generally depart from the optimal choice by a small margin.

To complete the definition of delay probability density f; we define the probability of leaving without getting service. Let d*₊=arg max_{d≧0}u_{θ}(d)−p(d), wherein the maximum is only obtained over the choices where service is received. In one embodiment of the present invention, we model the probability of receiving service P{d≠d_\θ,p(.)} as being proportional to the ratio of the best G-value among the available service levels to the G-value of leaving without service, hence:

$$\begin{matrix}\frac{P \{ d \neq {d}_{-} \vert θ , p ( . ) \}}{P \{ d = {d}_{-} \vert θ , p ( . ) \}} = \frac{G ( [ {u}_{0}^{θ , p} - ( {u}_{θ} ( {d}_{+}^{*} ) - p ( {d}_{+}^{*} ) ) ] / σ )}{G ( [ {u}_{0}^{θ , p} - ( {u}_{θ} ( {d}_{-} ) - p ( {d}_{-} ) ) ] / σ )} \\ = \frac{G ( [ {u}_{0}^{θ , p} - ( {u}_{θ} ( {d}_{+}^{*} ) - p ( {d}_{+}^{*} ) ) ] / σ )}{G ( {u}_{0}^{θ , p} / σ )} .\end{matrix} \qquad ( 2 )$$

Note that Eqn. (2) suggests that one is still penalized for the departure of u₀^{θ,p}−(u_{θ}(d)−p(d)) from the optimum scaled by G. In the case that d_ is the optimal choice, we get u₀^{θ,p}=0 and any service choice d₁>0 incurs an unscaled penalty of −(u_{θ}(d₁)−p(d₁))≧0. Otherwise, if d*₊ is optimal, d_ incurs the penalty of u₀^{θ,p}=(u_{θ}(d*₊)−p(d*₊))≧0 for passing up the opportunity of achieving a positive value.

Referring back to Eqn. (1), we note that probability density function f is a function of utility function u_{θ}(d), wherein u_{θ}(d) is a function of both the customer types θ and the offered service levels d. Note that if we know the probability distribution of customer types θ, we can compute the distribution of the chosen service levels (i.e., delays) for any given price curve p(.) by integrating f with respect to θ. If we denote π(θ) as the distribution of θ, this can be expressed as:

f(d\p(.))=∫ f(d\θ, p(.))π(θ)dθ (3)

Note that function f(d\p(.)) represents a general service-level choice distribution which takes all customer types into consideration. If we can solve for Eqn. (3), we can then estimate customer behavior as a function of any given price curve. We show how to obtain distribution function π(θ) empirically from observed customer data below.

A Model for Distribution π(θ)

In one embodiment of the present invention, we assume that π function comes from a family of functions parameterized by a hyperparameter τ, and we can rewrite π(θ) as π(θ\τ). Let ξ(τ) denote the a priori distribution on τ, which summarizes the uncertainty about τ before seeing the actual customer data. After collecting customer data from N customers with observed delay vectors d=(dᵢ; 1≦i≦N), the posterior distribution of τ becomes:

$$\begin{matrix}\begin{matrix}ξ \text{(} τ \vert d ) ∝ ξ ( τ ) \int f ( d \vert θ , τ ) \\ π ( θ \vert τ ) d θ\end{matrix} = ξ ( τ ) {\prod }_{i = 1}^{N} \int π ( {θ}_{i} \vert τ ) f ( {d}_{i} \vert {θ}_{i} ) d {θ}_{i} \\ = ξ ( τ ) {\prod }_{i = 1}^{N} \int π \text{(} {θ}_{i} \vert τ ) {\prod }_{i = 1}^{{n}_{i}} \\ [ \frac{1}{K ( {θ}_{i} , {p}_{ij} )} G ( \frac{{u}_{0}^{{θ}_{i} , {p}_{ij}} - ( {u}_{{θ}_{i}} ( {d}_{ij} ) - {p}_{ij} ( {d}_{ij} ) )}{σ} ) \\ {1}_{\{ {d}_{ij} \neq {d}_{-} \}} + P \{ {d}_{ij} = {d}_{-} \vert {θ}_{i} , {p}_{ij} \} {1}_{\{ {d}_{ij} = {d}_{-} \}} ] d {θ}_{i} ,\end{matrix} \qquad ( 4 )$$

wherein 1 is the indicator function. The desired distribution over θ is then given by:

π(θ\d)=∫ π(θ\τ)ξ(τ\d)dθ (5)

Selecting an Appropriate Form for Price Curve p(d)

It is necessary to ensure that both Eqns. (3) and (5) are computationally feasible. Moreover, because a constructed CBM is to be used as part of an optimization process for the service provider to choose an optimal price curve for his revenue/profit, the model for p(d) should allow for straightforward introduction of local changes to the curve. One can easily appreciate that without loss of generality the optimal p(d) can have a nonincreasing characteristic due to the fact that curve p′(d)=min_{s≦d}p(s) results in the same choices for all utility curves. In one embodiment, we expect p(d) to be convex.

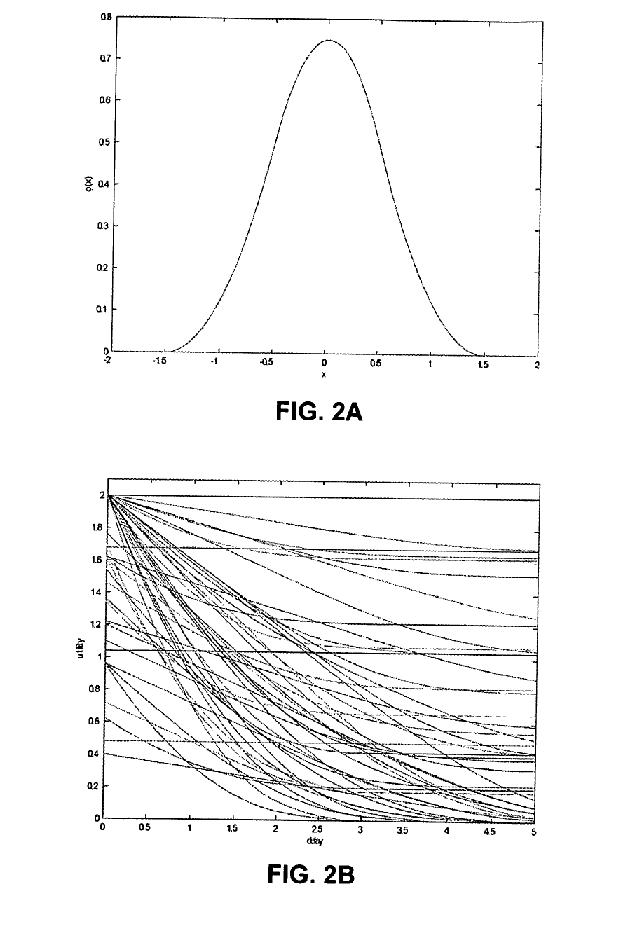

To impose derivative constraints on p(d) and to enable local changes during a future optimization process, we can use a particular wavelet basis and restrict expansion coefficients. Specifically, let φ(x) satisfy conditions set out in Lemma 1 described in Anastassiou, G. A. and Yu, X. M., “Convex and Coconvex Probabilistic Wavelet Approximation,” Stochastic Analysis and Applications, 10(5), 507-521, 1992. FIG. 2A illustrates a wavelet scaling function φ(x) in accordance with an embodiment of the present invention. Analytically, φ(x) has the form:

$$ϕ ( x ) = \{ \begin{matrix} 0 & x \leq - 1.5 , x \geq 1.5 \\ .5 {( 1.5 + x )}^{2} & - 1.5 \leq x \leq - .5 \\ 1 + x - {( .5 + x )}^{2} & - .5 \leq x \leq .5 \\ .5 {( 1.5 - x )}^{2} & .5 \leq x \leq 1.5\end{matrix} \qquad ( 6 )$$

### It has been shown in the above reference that for any integer k, function

$$p ( d ) = {\sum }_{j = - ∞}^{∞} {c}_{j} ϕ ( {2}^{k} d - j ) \qquad ( 7 )$$

is nonnegative and nonincreasing if coefficients cⱼ is a nonnegative nonincreasing sequence. Because in practice only a finite number of cⱼ are nonzero, we also note that if the support of φ is [−a; a], and g(d) is nonnegative nonincreasing for dε[0;+∞) if the first nonzero cⱼ occurs for j≦−a, and from that point on cⱼ are nonincreasing. It can be shown that if cⱼ is a convex sequence, i.e. increments cⱼ−cⱼ₋₁ are nondecreasing, then p(d) is a convex curve. Note that by varying coefficients cⱼ , p(d) can only change over [−a/2^{k}; a/2^{k}], which is desired.

We now describe a procedure to estimate the integral in Eqn. (3) in accordance with an embodiment of the present invention.

We use the expression of Eqn. (7) for the price curve p(d) and let

$${u}_{θ} ( d ) = {\sum }_{j = - ∞}^{∞} {θ}_{j} ϕ ( {2}^{k} d - j )$$

be the utility function for customer type θ. Note that we used the same k value for both p(d) and u_{θ}(d) for simplicity. Hence, Eqn. (1) can be written as:

$$f ( d \vert θ , p ( . ) , d \neq d\_ ) = \frac{1}{K ( θ , p )} G ( \frac{[ {max}_{{d}^{′}} {\sum }_{j = - ∞}^{∞} ( {θ}_{j} - {c}_{j} ) ϕ ( {2}^{k} {d}^{′} - j ) ] - ( {u}_{θ} ( d ) - p ( d ) )}{σ} ) . \qquad ( 8 )$$

For the chosen φ in Eqn. (6), it can be shown that:

$${max}_{{d}^{′}} {\sum }_{j = - ∞}^{∞} {a}_{j} ϕ ( {2}^{k} {d}^{′} - j ) = {max}_{j : {a}_{j} \geq {a}_{j - 1} , {a}_{j + 1}} \frac{3 {a}_{j}^{2} - {a}_{j} ( {a}_{j + 1} - {a}_{j - 1} )}{2 ( 2 {a}_{j} - {a}_{j + 1} - {a}_{j - 1} )} , \qquad ( 9 )$$

wherein the maximum is achieved on the boundary on the delay region.

The complexity of Eqn. (9) has two consequences. First, the normalization constant K(θ;p) in Eqn. (1) is difficult to obtain because it requires numerical integration over a convex domain of vector θ. Second, the evaluation of the integral in the right-hand side of Eqn. (4) and subsequent computations for Eqn. (5) is generally intractable for realistic π(θ\τ). Because the distribution of f is in general not computable, a standard Monte Carlo technique for drawing a sample from Eqn. (4) can not be implemented.

One embodiment of the present invention reduces the space of customer types θ to a moderately sized representative collection θₘ, wherein 1≦m≦M, which are associated with a finite number of utility functions u_{θm}(d). In this embodiment, computation of normalization constants K in Eqn. (4) and subsequent computation of the integrals become sums, which becomes easier to compute for a given τ. Furthermore, service-level choice distributions f(d\θ, p(.)) now becomes discrete distributions f(d\θₘ, p(.)).

Ideally, the collection θₘ should be chosen to avoid redundancy in covering the space of nonincreasing convex sequences, so that the collection is as representative as possible given its size. In one embodiment, we choose θₘ by using a maximum entropy experimental design technique described in Currin, C., Mitchell, T. J., Morris, M. D., and Ylvisaker, D., “Bayesian Prediction of Deterministic Functions, with Applications to the Design and Analysis of Computer Experiments,” Journal of American Statistical Association, 86, 953-963, 1991 (or “Currin” hereafter.)

Specifically, this technique chooses the M utility curves to fill the utility versus delay space uniformly. Furthermore, M is chosen sufficiently large so that no part of the space remains unexplored. Note that the local nature of the chosen wavelet representation of the utility curves allows us to substitute vector distances for curve distances, so that the techniques in Currin can be used directly. The convexity constraint is imposed within the search technique of Currin by disallowing the search paths to wander outside the nonincreasing-convexity domain. As an example, FIG. 2B illustrates 50 (M=50) utility curves u_{θ} for a particular choice of parameters in the Currin technique in accordance with an embodiment of the present invention.

Estimating Eqn. (1) for G(x)=exp(-x)

We consider an important case of G(x)=exp(-x). This choice of G implies that the relative probability of two delay choices d₁ and d₂ only depend on the utility gain (u_{θ}(d₁)−p(d₁))−(u_{θ}(d₂)−p(d₂)) and not on the utility level. In this case, u₀^{θ,p} can be removed from Eqn. (1) because it can be combined into the normalization constant K(θ, p), and Eqn. (1) becomes:

$$f ( d \vert θ , p ( . ) ) ∝ G ( \frac{- ( {u}_{θ} ( d ) - p ( d ) )}{σ} ) = exp ( \frac{{u}_{θ} ( d ) - p ( d )}{σ} ) .$$

Note that u_{θ}(d) is bounded, so that the density is proper over bounded delays. Using the conventions leading to Eqn. (8), and letting aⱼ=θⱼ−cⱼ , and k=0 to simplify the notation, we get

$$f ( d \vert θ , p ( . ) ) ∝ exp ( {\sum }_{j = - ∞}^{∞} {a}_{j} ϕ ( d - j ) / σ ) .$$

### For

$$d ∈ [ i - 0.5 , i + 0.5 ] , \\ {\sum }_{j = - ∞}^{∞} {a}_{j} ϕ ( d - j ) = ( {a}_{i + 1} + {a}_{i - 1} - 2 {a}_{i} ) {( d - i )}^{2} / 2 + ( {a}_{i + 1} - {a}_{i - 1} ) ( d - i ) / 2 + ( 6 {a}_{i} + {a}_{i + 1} + {a}_{i - 1} ) / 8 \hat{=} {{l}_{i 1} ( d - i )}^{2} / 2 + {l}_{i 2} ( d - i ) + {l}_{i 3} ,$$

wherein lᵢₖ are the linear functions in aⱼ. Denoting

$$I ( x ) = {\int }_{- ∞}^{x} exp ( {s}^{2} / 2 ) d s ,$$

which is not available in closed form, K(θ, p) becomes:

$$K ( θ , p ) = {\sum }_{i = - ∞}^{∞} \frac{exp ( {l}_{i 3} - {l}_{i 2}^{2} / ( 2 {l}_{i 1} ) )}{\sqrt{{l}_{i 1}}} [ I ( \frac{{l}_{i 2}}{\sqrt{{l}_{i 1}}} + \frac{\sqrt{{l}_{i 1}}}{2} ) - I ( \frac{{l}_{i 2}}{\sqrt{{l}_{i 1}}} - \frac{\sqrt{{l}_{i 1}}}{2} ) ] {1}_{\{ {l}_{i 1} \neq 0 \}} .$$

### Hence, we obtained normalized probability density distribution of Eqn. (1).

However, it is also clear that it is infeasible to compute the integrals in the right-hand side of Eqn. (4). Consequently, even for a simple exponential form of G, the implementation issues associated with the general modeling scheme remain.

A Model for τ

We now describe a model for r that will facilitate computing the right-hand side of Eqn. (4). We first select a moderate collection τ′ₖ, wherein 1≦k≦K. Let πₖ(θ)=π(θ\τ′ₖ). Because the integrals in Eqn. (4) become sums, it becomes simpler to evaluate them for each k as noted above. We denote these by Iₖ(dᵢ):

Iₖ(dᵢ)=∫ πₖ(θ)f(dᵢ\θ)dθ (10)

We now consider the set of distributions over θ obtained by mixing the πₖ(θ). Let τ stand for the mixing vector, π(θ\τ)=Στₖπₖ(θ) with Στₖ=1, τₖ≧0.

### Then

$$ξ ( τ \vert d ) ∝ ξ ( τ ) {\prod }_{i = 1}^{N} \sum {τ}_{k} {I}_{k} ( {d}_{i} ) ,$$

which is a polynomial in the τₖ. Eqn. (5) then becomes:

$$π ( θ \vert d ) ∝ {\sum }_{l} {π}_{l} ( θ ) \int {τ}_{l} ξ ( τ ) {\prod }_{i = 1}^{N} {\sum }_{k = 1}^{K} {τ}_{k} {I}_{k} ( {d}_{i} ) d τ \qquad ( 11 )$$

wherein the integrand in Eqn. (11) is a polynomial in the τₖ. Thus the (K−1)-dimensional integral can be evaluated analytically over Στₖ=1 provided Σ(τ) has a simple form. In one embodiment, we choose ξ(τ)=1. Because the number of summands in the integral is K^{N}, it would be computationally intractable. However, note that the integrals in Eqn. (11) compute the means of the τₖ under ξ(τ\d) and therefore Monte Carlo methods can be used to facilitate the evaluation.

In one embodiment of the present invention, we use Gibbs sampler technique (see Gilks, W. R., Richardson, S., and Spiegelhalter, D. J., “Markov Chain Monte Carlo in Practice,” Chapman and Hall, Boca Raton, Fla., 1996) to generate a sample of τ^{(j)}, 1≦j≦J with a limiting distribution Σ(τ\d) by resampling one coordinate τₖ, 1≦k≦K−1 at a time in a round-robin fashion. During an update of τ₁, the new value τₗ^{(j+1)} is sampled from the Gibbs update density for ξ(τₗ\d, τ₋ₗ^{(j)}), wherein τ₋ₗ stands for the vector of all coordinates except for the lth one. Note that ξ(τₗ\d, τ₋ₗ) is a univariate polynomial of degree N with an interval support [0,1−Σ_{k≠l}τₖ]. τ_{K} is updated after every Gibbs update via τ_{K}^{(j)}=1−Σₖ₌ₗ^{K-1}τₖ^{(j)}. After the sample is computed, the integrals in (11) are estimated by:

$$\int {τ}_{l} ξ ( τ ) {\prod }_{i = 1}^{N} {\sum }_{k = 1}^{K} {τ}_{k} {I}_{k} ( {d}_{i} ) d τ \approx \frac{1}{J} {\sum }_{j = 1}^{J} {τ}_{l}^{( j )} , \qquad ( 12 )$$

and the evaluation of (11) is now convenient.

Process for Computing Service-Level Choice Distribution

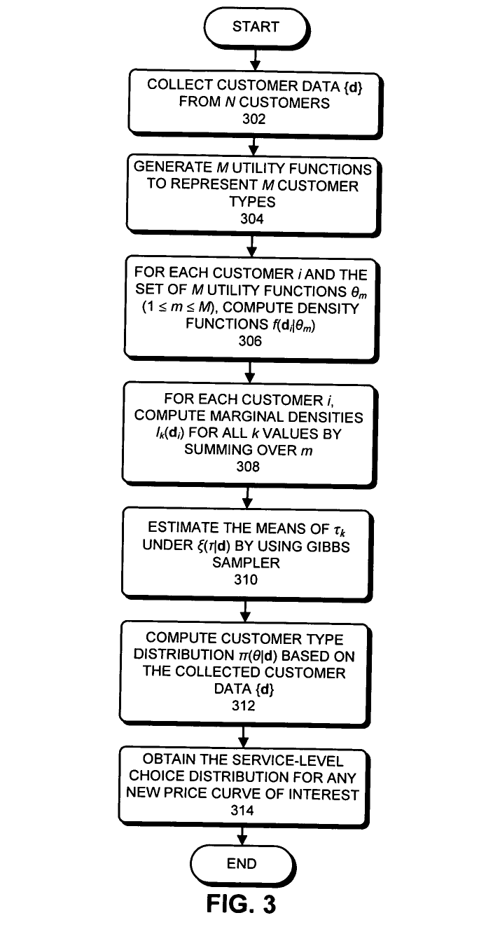

FIG. 3 presents a flowchart illustrating the process of computing the service-level choice distribution in accordance with an embodiment of the present invention.

The system starts by collecting customer data from N customers during service operation (step 302). Specifically, the system records pairs of price curves offered to customers and the corresponding service-level choices (including leaving without receiving service) made by the customers in response to the price curves. The system also keeps track of pairs of data points that are associated with the same customer (i.e., the same customer-service-level choice).

The system then generates M nonincreasing convex curves to serve as a representative collection of the set of customer utility functions, wherein each utility function represents a specific customer type (step 304). Note that ideally, the M curves are chosen to uniformly occupy the utility space. Also note that each of the N customers can be classified into of the M customer types.

Next, for each customer i and the set of utility functions, the system computes density functions f(dᵢ\θₘ), wherein 1≦m≦M, dᵢ represents the set of customer data collected for customer i, and θₘ represents the set of M utility functions (step 306).

For each customer i, the system next computes marginal densities Iₖ(dᵢ) for all k values of the hyperparameter by summing over m using Eqn. (10) (step 308).

The system then estimates the means of the τₖ under ξ(τ\d) by using Gibbs sampler (step 310). Next, the system computes customer type distribution π(θ\d) based on the collected customer data d using Eqn. (11) (step 312).

Finally, the system uses Eqn. (3) to obtain the service-level choice distribution f(d\p(.)), which can then be used to evaluate customer behavior for any price curve p(d) of interest (step 314).

Note that above-described process is related to kernel density estimation. The latter estimator, somewhat generalized, is defined by:

$$π ( θ \vert {d}_{i} , 1 \leq i \leq N ) = \frac{1}{N} {\sum }_{i = 1}^{N} K ( \frac{ρ ( {d}_{i} , θ )}{σ} ) ,$$

wherein K is the kernel, ρ is a distance between the customer observation vector and the behavior parameter. Combining observations from the same customer and using G as before, we obtain:

$$π ( θ \vert d ) = \frac{1}{N} {\sum }_{i = 1}^{N} \frac{1}{K ( {d}_{i} )} {\prod }_{j = 1}^{{n}_{i}} G ( \frac{{u}_{0}^{θ , {p}_{ij}} - ( {u}_{θ} ( {d}_{ij} ) - {p}_{ij} ( {d}_{ij} ) )}{σ} ) ,$$

wherein K(dᵢ) is the normalization constant for the product. To compute K(dᵢ), the product must be integrated over θ. Thus, u₀^{θ,p}^{ᵢⱼ} remains under the integral sign even for the exponential G and this integration is difficult in view of Eqn. (9).

Additionally, estimator (13) is sensitive to a particular choice of a moderately sized collection of θ. As a simple example, consider two candidates θ₁ and θ₂ versus θ₁, θ₂ and θ₃≈θ₁ and suppose the true π(θ) gives the weights of ½ to θ₁ and θ₂. In the first case, the estimator works well. In the second case, however, θ₁ and θ₃ receive approximately equal weights because they are close to each other and close to the weight of θ₂ because θ₁ and θ₂ are equally likely. Upon normalization, the estimate becomes approximately (⅓, ⅓, ⅓), which is incorrect. The proposed procedure resolves this problem by introducing parameter r that indexes candidate distributions of θ.

### Example of Computing Service-Level Choice Distribution

We apply the proposed technique to construct a CBM based on customer data generated from a simulator. A nonincreasing convex utility curve is generated at random for each customer by drawing a nonincreasing convex sequence uniformly from the unit cube and using it as wavelet basis expansion coefficients as shown in Eqn. (7). We use a set of four price curves for training and another set of five price curves for testing. These price curves are illustrated in FIG. 4A, wherein four prices curves used for training are shown as solid lines and five prices curves used for testing are shown as dashed lines.

Although in actual service environment, one does not expect drastic changes to the price curve, we allow a fair degree of disparity to illustrate the effectiveness of the present technique. Note that each customer can make between one and four choices with the training curves drawn at random without replacement. Hence, we have between one and four data points for each customer. We also use G(x)=exp(−x) with σ=0.2. Furthermore, we carry out the experimental design procedure to generate 100 generic customer types θ that are similar to those ploted in FIG. 2B. We use the collection of distributions τ′ₖ, 1≦k≦100 with τ′ₖ(θ)=1_{{θ=θk}}, which puts the unit mass on the corresponding θₖ. In the first example we collect data from 1,500 customers.

FIG. 4B illustrates the cumulative distribution functions of the chosen delays corresponding to price curves 3 (in the training set), 6 and 9 (in the. test set) in accordance with an embodiment of the present invention. The solid curves are the estimates from the proposed technique while the dashed ones are those for the empirical distribution of the simulated data, wherein the test curves 6 and 9 were not used for the construction of the CBM). Note that the vertical space at the delay of 5 between the cdf value on the curve and cdf=1 is the probability that a customer leaves without receiving service. The close match within the corresponding pairs of curves is apparent in FIG. 4B.

Table 1 summarizes the comparison of the estimated and simulated data for all nine price curves in FIG. 4A in accordance with an embodiment of the present invention. Rows 1 and 2 of Table 1 show the means and standard deviations of the chosen delay in the nine delay distributions given that the customer indeed receives service. Rows 3 and 4 show the probabilities that a customer leaves without receiving a service. Furthermore, we report in rows 5 and 6 the mean revenue obtained from servicing a customer assuming that the corresponding SLA is fulfilled and so no penalty is assessed. Note that the data show close match between the estimated (“est”) and actual quantities (“obs”).

In the second example we confine the study to 200 customers, but allow them to make 23 choices for 23 different price curves. This situation may arise when customers keep submitting jobs with similar requirements upon their completion. The amount of data is roughly the same as that in the first example.

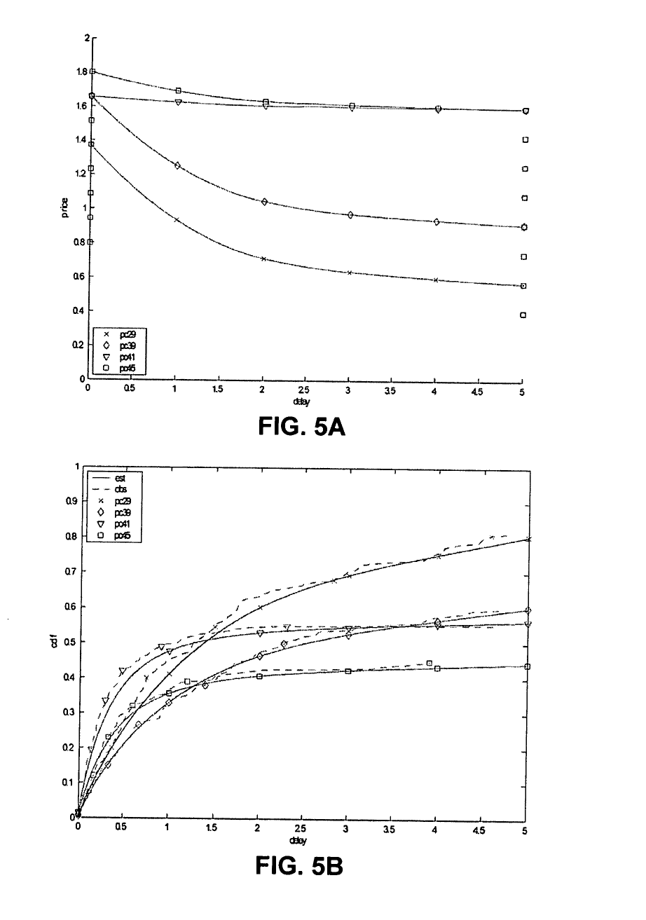

FIG. 5A illustrates four of the set of 22 test price curves generated for collecting customer data in accordance with an embodiment of the present invention. All the training and test curves (including those shown) are obtained by connecting the squares shown along the vertical line at the delay of zero in FIG. 5A with those at the delay of five while keeping only nonincreasing curves. FIG. 5B illustrates the estimated and simulated delay distributions for the four test curves plotted in FIG. 5A in accordance with an embodiment of the present invention. The accuracy of our results is comparable to those shown in Table 1 for the first example. In particular, the mean revenue per transaction is 3.8% off on average across the 22 test curves.

### CONCLUSION

The present invention provides a technique for constructing a customer behavior model (CBM) which predicts a service-level choice that a typical customer would make when offered an arbitrary price curve. The model is trained using the actual choices that customers make during routine service activities. Note that the CBM can be used to facilitate a price curve optimization process, wherein a wide range of price curves can be evaluated to select one that maximizes service provider profit. To facilitate this optimization process, the price curve is modeled through a particular wavelet basis to allow easy introduction of local changes to it. The same model for the price curve is used for modeling the utility curves, which not only simplifies computations, but also allows substituting vector distances for curve distances in the experimental design procedure.

There are a number of useful extensions to the proposed model. One such extension involves a situation where the event of a customer leaving without receiving a service is either completely unobservable or may take place for reasons other than being prices are too high at all service levels. We conjecture that such a complication may be alleviated by adopting a script that would invoke a pop-up question to a leaving customer to state the reason for leaving.

Note that the proposed model can be easily made adaptive to changing market conditions. Specifically, more recent observations can carry greater weight by raising the corresponding data density terms in Eqn. (4) to an annealing-type (see Sorin, D. J., Lemon, J. L., Eager, D. L., and Vernon, M. K. 2003, “An Analytic Evaluation of Shared-Memory Architectures,” IEEE Transactions on Parallel and Distributed Systems 14(2), 166-180) power greater than one. For example, a power of two would be equivalent to having another identical observation.

Another useful extension relates to updating the target distribution π(θ\d) when new data come in. Because we expect customers to provide new data points on a regular basis, it would be unacceptable to recompute the target distribution from scratch each time. Instead, we can use importance weights (see Matick, R. E., Heller, T. J., and Ignatowski, M., “Analytical analysis of finite cache penalty and cycles per instruction of a multiprocessor memory hierarchy using miss rates and queuing theory,” IBM Journal of Research and Development 45(6), 819-842, 2001) on the sample generated using Gibbs sampler to correct for the changing ξ(τ\d) by taking a weighted average in Eqn. (12) with the weights defined as normalized ratios of the new ξ(τ\d) over the old ξ(τ\d) evaluated at the sampled τ. Although the Iₖ(dᵢ) corresponding to the new data need to be reevaluated, no additional sampling is necessary for incremental changes.

Note that seasonality may play an important role in defining customer preferences. For example, flower shops get most business around Valentine's Day and Mother's Day. The utility from a single transaction typically increases since the shop can charge higher prices during these periods. The rate of arrivals also increases. Payroll activity picks up at the end of each quarter and during the tax season. Large computational jobs are more likely to be submitted during the work day. At times the results are needed by next morning, but there is no utility from receiving them earlier in the middle of the night. To take seasonality into account, we can introduce the time variable into the utility curves as u_{θ}(d, t). Interchanging low- and high-pass filtering, we can separate seasonality effects of different periods (days, quarters, etc.) similarly to the process described in Karkhanis, T. S. and Smith, J. E., “A First-Order Superscalar Processor Model,” In Proceedings of the 31th International Symposium on Computer Architecture, 2004.

Note that the proposed model construction process assumes to deal with one particular service type for all customers for simplicity. In a more realistic setting of several types of services or transactions, for example, both voice and video connections, both “browse” and “sell” transactions (with different service levels offered within each type), the proposed procedure can be repeated for different service types. For instance, an e-commerce business derives different utilities from “browse” and “sell” transactions and this should be reflected by offering different price curves.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

TABLE 1

| | pc1 | pc2 | pc3 | pc4 |
|---|---|---|---|---|
| Delay (est) | .74, .94 | 1.05, 1.13 | 2.03, 1.34 | .95, 1.08 |
| Delay (obs) | .74, .90 | 1.03, 1.08 | 2.04, 1.30 | .90, 1.04 |
| P{leave} (est) | .11 | .25 | .30 | .51 |
| P{leave} (obs) | .08 | .22 | .31 | .54 |
| Revenue (est) | .91 | .89 | .57 | .76 |
| Revenue (obs) | .93 | .91 | .56 | .72 |

| | pc5 | pc6 | pc7 | pc8 | pc9 |
|---|---|---|---|---|---|
| Delay (est) | 1.17, 1.19 | 1.58, 1.31 | .64, .86 | 1.48, 1.28 | .57, .79 |
| Delay (obs) | 1.13, 1.10 | 1.63, 1.28 | .63, .80 | 1.45, 1.24 | .53, .71 |
| P{leave} (est) | .08 | .18 | .27 | .44 | .53 |
| P{leave} (obs) | .08 | .18 | .25 | .47 | .56 |
| Revenue (est) | .72 | .69 | 1.02 | .69 | .82 |
| Revenue (obs) | .72 | .68 | 1.04 | .66 | .78 |

What is claimed is:

1. A method for modeling customer behavior in a multi-choice service environment, the method comprising:
constructing a probability density function f to represent probabilities of service-level choices made by customers, wherein the probability density function f is a function of functional variables u_{θ}(d) and p(d),
wherein u_{θ}(d) is a utility function for a specific customer type indexed by vector θ;
wherein p(d) is a given price curve which specifies a relationship between service levels offered by a service provider and corresponding prices for the offered service levels; and
wherein u_{θ}(d) and p(d) are both functions of offered service levels d.
obtaining a distribution function π(θ) which specifies a probability distribution of different customer types θ; and
obtaining a service level-choice distribution for a population of customers as a function of a given price curve based on the probability density function f and π(θ).

2. The method of claim 1, wherein the method further comprises:
using the service-level choice distribution to estimate customer behavior for any given price curve; and
using the service-level choice distribution to estimate a rate of customers receiving services for any give price curve.

3. The method of claim 1, wherein the probability density function f is proportional to a nonnegative decreasing function
$$G ( \frac{{u}_{0}^{θ , p} - ( {u}_{θ} ( d ) - p ( d ) )}{σ} ) ,$$
wherein u₀^{θ,p} is an optimal utility gain under p(d) for customer type θ;
wherein u_{θ}(d)−p(d) is the utility gain under p(d) for customer type θ;
wherein u₀^{θ,p}−(u_{θ}(d)−p(d)) represents a departure from the optimal utility gain for customer type 0; and
wherein σ is a constant which represents the extent of the departure from the optimal utility gain.

4. The method of claim 1, wherein obtaining the service level-choice distribution f(d\p(d)) for a given price curve p(d) based on the probability density function f and π(θ) involves integrating over the customer type θ using:
f(d\p(d))=∫ f(d\θ, p(d))π(θ)dθ.

5. The method of claim 1, wherein the service-level choices include leaving without receiving service.

6. The method of claim 1, wherein obtaining the distribution function π(θ) involves:
collecting service-level-choices data {d} from a population of N customers; and
computing the distribution function π(θ) by computing a distribution function π(θ\d) based on the service-level-choices data {d}.

7. The method of claim 6, wherein collecting service-level-choices data {d} from the N customers involves:
offering the N customers with one or more price curves; and
for each customer i, recording one or more service-level choices dᵢ made by the customer i based on each offered price curve.

8. The method of claim 6, wherein collecting service-level-choices data {d} from the N customers involves collecting one or more identical service-level-choices made by a same customer.

9. The method of claim 6, wherein obtaining the distribution function π(θ\d) involves:
obtaining a distribution function π(θ\τ), wherein τ is a hyperparameter;
obtaining a distribution function ξ(τ\d) for the hyperparameter τ giving the collected data {d}; and
computing the distribution function π(θ\d) by performing the integral:
π(σ\d)=∫ π(θ\τ)ξ(τ\d)dθ.

10. The method of claim 9, further comprising generating a representative collection of utility functions to represent a plurality of customer types θₘ, wherein the collection of utility functions uniformly cover a space containing different utility functions.

11. The method of claim 10, wherein the collection of utility functions are represented by nonincreasing convex curves.

12. The method of claim 10, wherein computing the distribution function π(θ\d) involves computing a probability density vector f(dᵢ\θₘ) for each customer i over the plurality of customer types θₘ.

13. The method of claim 9, wherein obtaining the distribution function π(θ\τ) involves using a Gibbs sampler.

14. The method of claim 1, further comprising representing p(d) as a combination of a wavelet basis, thereby facilitating varying p(d) during an optimization process using the service-level choice distribution.

15. The method of claim 12, wherein the method further comprising updating the distribution function π(θ\d) when new customer data is added in {d}.

16. A computer-readable storage medium storing instructions that when executed by a computer cause the computer to perform a method for modeling customer behavior in a multi-choice service environment, the method comprising:
constructing a probability density function f to represent probabilities of service-level choices made by customers, wherein the probability density function f is a function of functional variables u_{θ}(d) and p(d),
wherein u_{θ}(d) is a utility function for a specific customer type indexed by vector θ;
wherein p(d) is a given price curve which specifies a relationship between service levels offered by a service provider and corresponding prices for the offered service levels; and
wherein u_{θ}(d) and p(d) are both functions of offered service levels d.
obtaining a distribution function π(θ) which specifies a probability distribution of different customer types θ; and
obtaining a service level-choice distribution for a population of customers as a function of a given price curve based on the probability density function f and π(θ).

17. The computer-readable storage medium of claim 16, wherein the method further comprises:
using the service-level choice distribution to estimate customer behavior for any given price curve; and
using the service-level choice distribution to estimate a rate of customers receiving services for any give price curve.

18. The computer-readable storage medium of claim 16, wherein the probability density function f is proportional to a nonnegative decreasing function
$$G ( \frac{{u}_{0}^{θ , p} - ( {u}_{θ} ( d ) - p ( d ) )}{σ} ) ,$$
wherein u₀^{θ,p} is an optimal utility gain underp(d) for customer type θ;
wherein u_{θ}(d)−p(d) is the utility gain underp(d) for customer type θ;
wherein u₀^{θ,p}−(u_{θ}(d)−p(d)) represents a departure from the optimal utility gain for customer type θ; and
wherein σ is a constant which represents the extent of the departure from the optimal utility gain.

19. The computer-readable storage medium of claim 16, wherein obtaining the service level-choice distribution f(d\p(d)) for a given price curve p(d) based on the probability density function f and π(θ) involves integrating over the customer type θ using: f(d\p(d))=∫ f(d\θ, p(d))π(θ)dθ.

20. The computer-readable storage medium of claim 16, wherein the service-level choices include leaving without receiving service.

21. The computer-readable storage medium of claim 16, wherein obtaining the distribution function π(θ) involves:
collecting service-level-choices data {d} from a population of N customers; and
computing the distribution function π(θ) by computing a distribution function π(θ\d) based on the service-level-choices data {d}.

22. The computer-readable storage medium of claim 21, wherein collecting service-level-choices data {d} from the N customers involves:
offering the N customers with one or more price curves; and
for each customer i, recording one or more service-level choices dᵢ made by the customer i based on each offered price curve.

23. The computer-readable storage medium of claim 21, wherein obtaining the distribution function π(θ\d) involves:
obtaining a distribution function π(θ\τ), wherein τ is a hyperparameter;
obtaining a distribution function ξ(τ\d) for the hyperparameter τ giving the collected data {d}; and
computing the distribution function π(θ\d) by performing the integral:
π(θ\d)=∫ π(θ\τ)ξ(τ\d)dθ.

24. The computer-readable storage medium of claim 23, further comprising generating a representative collection of utility functions to represent a plurality of customer types θₘ, wherein the collection of utility functions uniformly cover a space containing different utility functions.

25. The computer-readable storage medium of claim 24, wherein computing the distribution function π(θ\d) involves computing a probability density vector f(dᵢ\θₘ) for each customer i over the plurality of customer types θₘ.

26. An apparatus that models customer behavior in a multi-choice service environment, comprising:
a construction mechanism configured to construct a probability density function f to represent probabilities of service-level choices made by customers, wherein the probability density function is a function of a functional variables u_{θ}(d) and p(d),
wherein u_{θ}(d) is a utility function for a specific customer type indexed by vector θ;
wherein p(d) is a given price curve which specifies a relationship between service levels offered by a service provider and corresponding prices for the offered service levels; and
wherein u_{θ}(d) and p(d) are both functions of the offered service levels d;
a computing mechanism configured to obtain a distribution function π(θ) which specifies a probability distribution of different customer types θ;
wherein the computing mechanism is configured to obtain a service level-choice distribution for a population of customers as a function of a given price curve based on the probability density function f and π(θ); and
an application mechanism configured to use the service-level choice distribution to estimate customer behavior for a given price curve.
